(19) United States
(12) Patent Application Publication
(10) Pub. No.: US 2008/0088528 A1
(43) Pub. Date: Apr. 17, 2008

(54) Warp Image Circuit

(76) Inventors: Takashi Shindo, Chino-shi (JP); Doug McFadyen, Delta (CA); Tatiana Pavlovna Kadantseva, Vancouver (CA); Kevin Gillett, South Surrey (CA); John Peter van Baarsen, Delta (CA); Keitaro Fujimori, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/550,392

(22) Filed: Oct. 17, 2006

(51) Int. Cl. G06F 15/00; G09G 5/00

(52) U.S. Cl. 345/7

(57) ABSTRACT

A heads up display (HUD) is provided. The HUD includes a projector configured to project a distorted representation of image data onto a non-planar surface. The HUD also includes warp image circuitry configured to store offsets to be applied to the image data to generate the distorted representation. The offsets represent respective distances for moving coordinates of a portion of pixels within the image data and the offsets are stored within a memory region of the warp image circuitry. The portion of pixels corresponds to vertices of polygons. The warp image circuitry is further configured to map the vertices of polygons to the non-planar surface. A method for projecting an image onto a warped surface is also provided.

### CROSS REFERENCE TO RELATED APPLICATIONS

This Application is related to application Ser. No. 11/550,180 (Atty Docket No. VP247) entitled “Calibration Technique for Heads Up Display System,” and application Ser. No. 11/550,153 (Atty Docket No. VP248) entitled “Method and Apparatus for Rendering an Image Impinging Upon a Non-Planar Surface.” These applications are herein incorporated by reference in their entireties for all purposes.

### BACKGROUND

In an attempt to enhance safety features for automobiles, heads up displays (HUD) are being offered as an option for purchasers of some automobile models. The virtual image is projected from the instrument panel onto the windshield. As windshields are not flat or perpendicular to the driver's eyes, the image must be corrected to ensure that it is undistorted and easy to read. In some solutions the use of a special wedge shaped intermediate layer is used to change the geometry of the glass and provide the optical correction needed for image reflection. In other an optical terms is manually adjusted by a technician during the manufacturing of the automobile to alter the image being projected so that the perceived image is undistorted.

However, all of the current solutions lack the ability to adjust to any changes of the projector, observer viewpoint, or changes to the windshield. Thus, when something changes after being originally set-up, the owner of the vehicle must take the vehicle in to have the system re-adjusted to accommodate the change. These limitations make the currently available HUD systems inflexible and costly.

As a result, there is a need to solve the problems of the prior art to provide a HUD system that can be adjusted in a cost efficient manner in order to gain widespread acceptance with consumers.

### SUMMARY

Broadly speaking, the present invention fills these needs by providing a digital solution for a Heads Up Display that is flexible. It should be appreciated that the present invention can be implemented in numerous ways, including as a process, an apparatus, a system, a device, or a method. Several inventive embodiments of the present invention are described below.

In one embodiment, a heads up display (HUD) is provided. The HUD includes a projector configured to project a distorted representation of image data onto a non-planar surface. The HUD also includes warp image circuitry configured to store offsets to be applied to the image data to generate the distorted representation. The offsets represent respective distances for moving coordinates of a portion of pixels within the image data and the offsets are stored within a memory region of the warp image circuitry. The portion of pixels corresponds to vertices of polygons. The warp image circuitry is further configured to map the vertices of polygons to the non-planar surface.

In another embodiment, a warp image circuit is provided. The warp image circuit includes a memory region storing offsets to be applied to image data to generate a distorted representation of the image data. A core region configured to map the image data to a non-planar surface and calculate an amount of distortion introduced into polygon sections of the image data on the non-planar surface is included. The core region is further configured to determine an inverse of the amount of distortion to be applied to the image data to negate the amount of distortion introduced by the non-planar surface. An interface module enabling communication between the memory region and the core region is provided. The interface module includes a counter to determine one of whether to read offset data from the memory region to calculate a pixel location or to interpolate the pixel location through the core region.

In yet another embodiment, a method for projecting an image onto a warped surface so that the image is perceived as being projected onto a non-warped surface is provided. The method includes subdividing a calibration image into blocks and determining offsets for each of the vertices of the blocks, where the offsets are caused by the warped surface. The method further includes applying the offsets to image data coordinates and determining coordinates for image data not associated with the offsets. The image data adjusted as to the offsets is inverted and the coordinates for the image data not associated with the offsets are also inverted. The inverted image data is directed to the warped surface.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating a heads-up display system for use in a vehicle in accordance with one embodiment of the invention.

FIG. 2 is a simplified schematic diagram illustrating the application of offsets applied to an original image in accordance with one embodiment of the invention.

FIG. 3 is a simplified schematic diagram illustrating the image representation generated by the warp circuit and illustrating a backwards mapping technique in accordance with one embodiment of the invention.

FIG. 4 is a simplified schematic diagram illustrating a quadrilateral in which a bilinear interpolation function is applied in accordance with one embodiment of the invention.

FIG. 5 is a simplified schematic diagram further illustrating the functional blocks of the warp image circuitry in accordance with one embodiment of the invention.

FIG. 6 is a flowchart diagram illustrating the method operations for projecting an image onto a warped surface so that the image is perceived as being projected onto a non-warped surface in accordance with one embodiment of the invention.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

A warp image circuit is described below. The warp image circuit may be incorporated into a Heads Up Display (HUD) for a vehicle. The warp image circuit is part of a system that provides a digital solution for a HUD system. As mentioned below, offset values stored within the warp image circuit are used to manipulate image data, e.g., change coordinates of a portion of the pixels of the image data, so that the image may be projected off of a non-planar surface and still be viewed as non-distorted. The embodiments described herein are directed to the circuitry and hardware for the digitally based HUD. It should be appreciated that while the embodiments described below reference a HUD for an automobile, this is not meant to be limiting. That is, the embodiments described herein may be incorporated into any vehicle, including sea based vehicles, such as boats, jet skis, etc., air based vehicles, such as planes, helicopters, etc., and land based vehicles, such as automobiles, motorcycles, etc., whether motor powered or not.

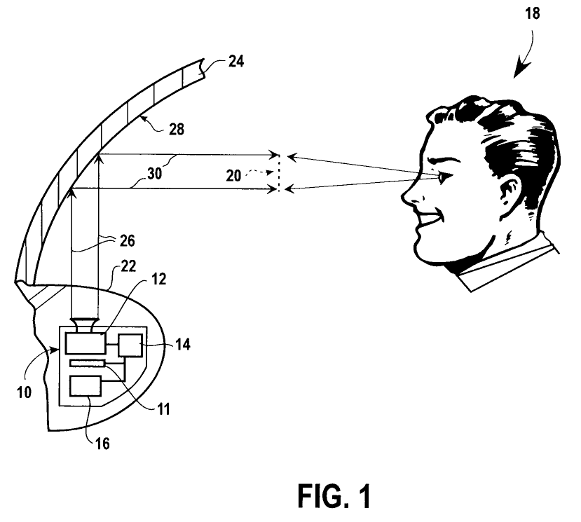

FIG. 1 is a simplified schematic diagram illustrating a heads-up display system for use in a vehicle in accordance with one embodiment of the invention. Image rendering device 12, such as a projector, includes hardware such as processor 14, memory 16 and warp image circuitry 11. It should be noted that warp image circuitry 11, may be referred to as warp image logic and may include software, hardware or some combination of both. Furthermore, the structure of warp image circuitry 11 includes logic gates that are interconnected to accomplish the functionality described herein. Thus, warped image circuitry may be embodied on a programmable logic device, e.g., a field programmable gate array (FPGA), an application specific integrated circuit (ASIC), etc., as one skilled in the art would recognize. The embodiments described herein provide further detail of warp image circuitry 11. As described in more detail below, warp image circuitry 11 functions to warp and/or to de-warp an image using a table of offset values. The table of offset values is provided through the embodiments described with regard to U.S. application Ser. No. 11/550,153 (Attorney Docket VP248) entitled “Method and Apparatus for Rendering an Image Impinging Upon a Non-Planar Surface.” The offset values are derived through data obtained by U.S. application Ser. No. 11/550,180 (Attorney Docket VP247) entitled “Calibration Technique for Heads Up Display system.” Both of these applications have been incorporated herein by reference.

Referring to FIG. 1, system 10 in accordance with one embodiment of the present invention includes an image rendering device 12, such as a projector, in data communication with a processor 14 that may be a general processor, finite state machine or any other circuit capable of manipulating image data as discussed herein. It should be appreciated that the image rendering device may be a liquid crystal display (LCD) projector or any other suitable projector for displaying the image data which may be impinged off of a non-planar surface or even displayed on a non-planar LCD screen. Memory 16 is in data communication with processor 14 and includes computer readable code to carry-out the functions in accordance with the present invention. Alternatively, the functionality may be accomplished through logic gates and circuitry configured to achieve the results described herein. Warp image circuitry 11 applies the offsets to the image data so that user 18 views non-distorted data that has been projected off or directed to non-planar surface 24. Image rendering device 12 is situated in a vehicle, such as an automobile, motorcycle, aircraft, boat, and the like, so that user 18 can visually perceive an image produced thereby in viewing region 20. Image rendering device 12 and corresponding components within system 10 function as a digitally based heads-up-display (HUD). In one embodiment, image rendering device 12 operates to render an image of desired instrumentations, in region 20 that is located in the field of view of user 18 in the ordinary operation of the vehicle. The image of the instrumentation cluster (not shown) is ordinarily present in dashboard 22. Typically, the content of the image rendered in region 20 is a real-time representation of the operation of the automobile that may be obtained employing standard techniques. For example, an image of a speedometer (not shown), tachometer (not shown), clock (not shown), compass (not shown), oil pressure gauge (not shown) and the like may be rendered in region 20. The information presented by the instrumentation cluster may be rendered in region 20, without rendering an image of the instrumentation cluster or the individual gauges contained therein. Alternatively, it is also possible that the image rendered in region 20 includes information concerning operational characteristics of the vehicle not presented by the instrumentation cluster, e.g., some automobiles are not provided with a tachometer; however, tachometer signals may be present in the vehicle. The present invention may be employed to render an image corresponding to tachometer signals in region 20. As a result the present invention is ideal for backwards compatibility to existing automobiles in that it affords the functionality of increasing the information perceivable by user 18 concerning operational characteristics of the vehicle. Furthermore, user 18 does not have to look down at the instrument panel as the information is projected in the line of sight to the roadway or path being traversed. In an alternative embodiment, data not associated with the instrumentation cluster and operating parameters of the vehicle, such as data associated with the radio and songs being played, data associated with a navigation system, etc., may be projected through the HUD.

In the present example, user 18 and region 20 are spaced-apart from a windshield 24 and positioned so that region 20 will be in a field of view of user 18 looking through windshield 24. This is achieved by image rendering device 12 projecting an image as a plurality of pixels, two of which are shown by rays 26, to impinge upon windshield 24, with image rendering device 12, processor 14, warp image circuitry 11, and memory 16 being mounted within a dashboard 22 from which windshield 24 extends. As shown, image rendering device 12 generates images in region 20 by having pixels reflect from a surface 28 of windshield 24, shown by rays 30 producing a virtual image of the original image in region 20. It should be appreciated that while system 10 is mounted in the dashboard, this is not meant to be limiting as the system may be placed in any suitable location, e.g., above the viewers head. In addition, processor 14, warp image circuitry 11, and memory 16 are shown as separate blocks, these block may be integrated onto a single chip in another embodiment. Of course, all of the components of system 10 may be incorporated into image rendering device 12 in one embodiment.

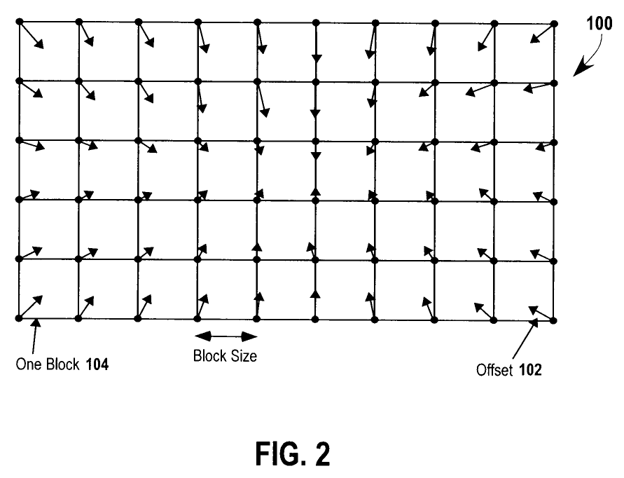

FIG. 2 is a simplified schematic diagram illustrating the application of offsets applied to an original image in accordance with one embodiment of the invention. Original image 100 is separated into blocks 104. In one embodiment, a block edge length is a power of 2 and the original image size is divisible by the block size. For example, when the image size is VGA, i.e., 640×480, the block size should be 2, 4, 8, 16, 32, etc. It should be appreciated that the blocks may be associated with a calibration image that is used to generate data used to estimate the amount of distortion introduced by a non-planar surface that original image 100 is directed towards. Offsets 102 are provided for each corner/vertices of blocks 104 in order to warp the original image so that when the image is directed to the non-planar surface, the image will appear to a viewer as being non-warped. As described below, the warp image circuitry applies the offsets to the blocks of image data and then stitches the image together for viewing. The data enabling the derivation of the offsets may be determined through a calibration grid or calibration points as specified in U.S. application Ser. No. 11/550,180 (Atty Docket VP247).

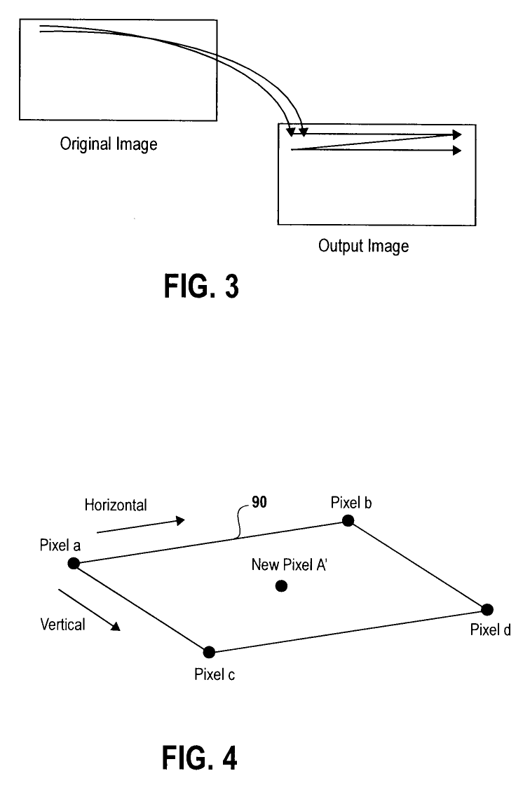

FIG. 3 is a simplified schematic diagram illustrating the image representation generated by the warp circuit and illustrating a backwards mapping technique in accordance with one embodiment of the invention. In the backwards mapping technique of FIG. 3 the output image is scanned from a left top to a right bottom region of the image and the best coordinate is calculated to be fetched from the input image. Table 1 provides the exemplary code used for this algorithm in accordance with one embodiment of the invention. As mentioned above, this code may be stored in memory to be executed by a processor or logic gates, e.g., adders, subtractors, dividers, multipliers, comparators, and other basic logic gates, may be defined to accomplish the functionality of this code.

TABLE 1

```
Block Power // Power of block edge length
BlockSize // Block edge length
BlocksinX // Number of horizontal edge
BlocksinY // Number of vertical edge
InputImage // Input image
OutputImage // Output Image
OffsetTable // Offset Table
x // Output image x coordinate
y // Output image y coordinate
xFraction // Pixel counter inside of block
yFraction // Line counter inside of block
xBlock // Horizontal block counter
yBlock // Vertical block counter
round // BlockSize * BlockSize / 2
for ( y = 0; y < OutputImage.Height ; y = y + 1 ) {
  for ( xBlock = 0; xblock < BlocksinX; xBlock = xBlock
+1 ) {
    (x1, y1) = OffsetTable(xBlock, yBlock);
    (x2, y2) = OffsetTable(xBlock+1, YBlock);
    (x3, y3) = OffsetTable(xBlock, yBlock+1);
    (x4, y4) = OffsetTable(xBlock+1, yBlock+1);
    (dxTop, dyTop) = ( x2, y2 ) − ( x1, y1 );
    (dxBot, dyBot) = ( x4, y4 ) − ( x3, y3 );
    ( x1, y1 ) = ( x1, y1 ) * BlockSize ;
    ( x3, y3 ) = ( x3, y3 ) * BlockSize;
  for ( xFraction = 0; xFraction < BlockSize; xFraction =
xFraction + 1 ) {
  xInput = x + (( x1 * BlockSize ) + yFraction * (x3 − x1 )
+ round ) / BlockSize\hat{ }2;
  yInput = y + (( y1 * BlockSize ) + yFraction * (y3 − y1 )
+ round ) / BlockSize\hat{ }2;
    *Copy pixel from InputImage to OutputImage
    ( x1, y1 ) = (x1, y1 ) + dxTop, dyTop );
    ( x3, y3 ) = ( x3, y3 ) + (dxBot, dybot );
    }
  }
}
```

FIG. 4 is a simplified schematic diagram illustrating a quadrilateral in which a bilinear interpolation function is applied in accordance with one embodiment of the invention. Quadrilateral 90 has pixels a through d at the corners, which may be referred to as vertices, and pixel A′ is located within the quadrilateral. The code within Table 2 illustrates a technique for applying bilinear interpolation function in order to determine the color components of pixel A′.

TABLE 2

| Assume the coordinates of New Pixel A′ is (X, Y). | |
|---|---|
| Xi, Yi is the integer part of the x and y. | |
| Xf, Yf is the fractional part of the x and y. | |
| Then the coordinates of the 4 nearest pixels are | |
| a ( Xi, Yi ) | |
| b ( Xi, Yi+1) | |
| c (Xi+1, Yi) | |
| d ( Xi+1, Yi+1) | |
| The Red components of the A′ is: | |
| R_{A′}= | Ra * ( 1 + Xi − X) * ( 1 + Yi − Y ) + |
| | Rb * ( X − Xi ) * ( 1 + Yi − Y ) + |
| | Rc * ( 1 + Xi − X ) * ( Y − Yi ) + |
| | Rd * ( X − Xi ) * (Y − Yi ) |
| | =Ra * ( 1 − Xf ) * ( 1 − Yf ) + |
| | Rb * Xf * ( 1 − Yf ) + |
| | Rc * ( 1 − Xf ) * Yf + |
| | Rd * Xf * Yf |

It should be appreciated that while the exemplary code finds the red component, the blue and green components may be determined in a similar manner. As described herein, the vertices of quadrilateral 90, i.e., the coordinates for pixels a-d, may be provided through offsets or absolute coordinates derived from calibration data, while the coordinates for the pixels within the quadrilateral, e.g., pixel A′, may be derived through interpolation.

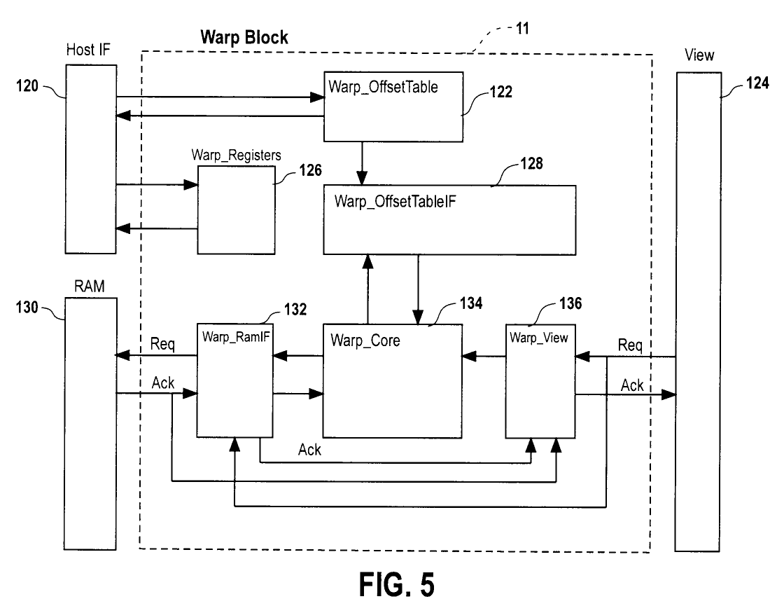

FIG. 5 is a simplified schematic diagram further illustrating the functional blocks of the warp image circuitry in accordance with one embodiment of the invention. Warp block 11 is in communication with host interface 120, random access memory (RAM) 130, and display panel 124. Within warp block 11 is warp offset table 122, which stores values representing the offsets for corresponding pixels to be displayed. Thus warp offset table 122 includes an arbiter and a memory region, e.g., RAM, for storing the offsets. It should be appreciated that warp offset table 122 contains relative values which may be thought of as distances from a portion of corresponding pixel values of the image to be displayed. The portion of corresponding pixel values corresponds to the vertices of the blocks of FIG. 2 in one embodiment. In an alternative embodiment, actual coordinates may be stored rather than the offsets. Warp register block 126 is included within warp block 11 and communicates with host interface 120. Warp register block 126 is a block of registers that sets the image size and/or the block size and initiates the bilinear interpolation discussed with regard to FIG. 4. One skilled in the art will appreciate that the actual design may distribute registers throughout warp block 11, rather than as one block of registers. Warp offset table interface 128 communicates with warp offset table 122 and functions as the interface for warp offset table 122. Warp offset table interface 128 includes a counter and reads the offsets from warp offset table 122 according to the corresponding pixel location being tracked. For example, for each pixel position the counter may be incremented to track the position being displayed/operated on within the image being displayed as per the order of rendering illustrated with regard to FIG. 3. Warp core 134 is in communication with warp offset table 128, warp RAM interface 132, and warp view interface 136.

Warp core 134 of FIG. 5 is the main calculation block within the warp circuit. Thus, warp core 134 calculates coordinates from the values in the offset table according to the location within the image, as provided by warp offset table interface 128. In one embodiment, warp offset table interface 128 transmits requested data to warp core 134 upon a signal received from the warp core that the warp core is ready. Once warp core 134 reads the data and transmits an acknowledge signal back to warp offset table interface 128, warp offset table interface 128 will begin to read a next set of offsets from warp offset table 122. Warp core 134 functions to map the image as a plurality of spaced-apart planar cells to coordinates of the non-planar surface, with each of the cells including multiple pixels of the image. The distance between the cells is minimized while minimizing a distance of each of the plurality of cells with respect to the surface coordinates and impinging the plurality of planar cells upon the non-planar surface as discussed in more detail in application Ser. No. 11/550,153 (Atty Docket No. VP248). As a brief overview of the functionality provided by warp circuit 11, and in particular warp core 134, the mapping of the image as a plurality of spaced apart cells includes associating pixels of the image with a plurality of polygons, each of which defines one of the plurality of spaced-apart cells and includes multiple vertices having an initial spatial relationship. The vertices, or corners, which correspond to the calibration points of the calibration image, are mapped to coordinates of the non-planar surface to produce mapped polygons. A matrix of distortion coefficients is generated from the vertices of the mapped polygons. The distortion coefficients define a relative spatial relationship among the pixels upon the non-planar surface. Produced from the distortion matrix is an inverse matrix having a plurality of inverting coefficients. The original image data is displayed as inverted polygons to negate distortions introduced when the image data is impinged off of a non-planar surface.

Still referring to FIG. 5, warp RAM interface 132 is in communication with RAM 130 and warp core 134. Additionally, warp RAM interface 132 communicates with warp view interface 136. Warp RAM interface 132 functions as an interface with external RAM 130. Warp RAM interface 132 will evaluate new coordinates derived from warp core 134 and if necessary, will read pixel data from random access memory 130. If a read from RAM 130 is unnecessary, e.g., the coordinate is outside of the image size, then warp RAM interface 132 communicates with warp view interface 136 to output background image to view block 124. In one embodiment, if bilinear interpolation is enabled through a register setting, if the coordinate is not one of the vertices having offset data, then warp RAM interface 132 will read the necessary pixel data from RAM 130 as outlined in Table 4. For example, from a coordinate provided by warp core 134, warp RAM interface 132 determines whether its necessary for apply bilinear interpolation based on the location of the coordinate or as detailed in Table 4. In another embodiment, less than four coordinates may be used for bilinear interpolation as specified in Table 4, e.g., where the coordinate is associated with a boundary. Warp RAM interface 132 reads the necessary data for this interpolation from RAM 130 and calculates a new pixel as described above with regard to FIG. 4. Warp view interface 136 includes a first in first out (FIFO) buffer and functions to enable synchronous communication with outside blocks such as an interface for display panel 124. Thus, warp view interface 136 sends pixel data to an outside block with an acknowledge signal when warp view interface 136 is not empty.

Table 3 illustrates exemplary functions for the modules within a warp image circuit of FIG. 5 in accordance with one embodiment of the invention. With regard to FIG. 5, Table 4 illustrates that the determination as to whether bilinear interpolation is needed through warp RAM interface 132. In order to minimize the number of reads into random access memory 130 a determination may be made as to the number of pixels to be read based on the location of the pixel. In Table 4, various calculations are made to determine whether pixels need to be read, and if pixels need to be read, how many. Less than four pixels may be read in one embodiment for the bilinear interpolation, as illustrated in Table 4, where the four pixels are the corners of a quadrilateral, such as the quadrilateral of FIG. 4.

TABLE 3

| MODULE NAME | FUNCTION |
|---|---|
| Warp_Registers | Host Interface and offset table interface. |
| Warp_OffsetTable | Offset table having a suitable size. |
| Warp_OffsetTableIF | Offset table interface. |
| | Read the offset table value for |
| | calculating coordinates. |
| Warp_RamIF | Ram interface. |
| | Address generator |
| | Bi-Linear function |
| Warp_ViewIF | View interface |
| | First-in-First out (FIFO) |
| Warp_Core | Main engine |
| | Main engine for calculating |
| | coordinates. |

TABLE 4

```
X = RegWarpImgX − 1
Y = RegWarpImgY − 1
Fx = Fractional_PartX
Fy − Fractional_PartY
if ( x < −0.5 ) | ( y < −0.5 ) | ( x>= ( X + 0.5)) | ( y >= ( Y + 0.5))
    No need to read
if ( −0.5 <= x < 0 ) & ( −0.5 <= y < 0 )
    Needs to read only point D.
if ( X <= x < ( X + 0.5 )) & ( − 0.5 <= y < 0 )
    Needs to read only point C.
if ( X <= x < 0 ) & ( Y <= < ( Y + 0.5 ))
    Needs to read only point B.
if ( X <= x < ( X + 0.5 )0 & ( Y <= y < ( Y + 0.5 ))
    Needs to read only point A.
if ( −0.5 <= x < 0 ) & ( 0 <= y < Y ) & ( Fy == ) )
    Needs to read only point B.
if ( 0 <= x < X ) & ( −0.5 <= y < 0 ) & ( Fx == 0 )
    Needs to read only point C.
if ( X <+ x < ( X + 0.5 )) & ( 0 <= y < Y ) & ( Fy == 0 )
    Needs to read only point A.
if ( 0 <= x < X ) & ( Y <= y < ( Y = 0.5 )) & ( Fx != 0 )
    Needs to read only point A.
if ( 0 <= x < X ) & ( 0 <= y < Y ) & (Fx == 0 ) & ( Fy==0)
    Needs to read only point A.
if ( −0.5 <= x < 0 ) & ( 0<= y < Y ) & (Fy != 0 )
    Needs to read point B and point D.
if (0 <= x < X ) & ( −0.5 <= y < 0 ) & ( Fx !=0 )
    Needs to read point C and point D.
if ( X <= x < ( X + 0.5 )) & ( 0<= y < Y ) & ( Fy!=0 )
    Needs to read point A and point C.
if ( 0 <= x < X ) & ( Y <= y < ( Y = 0.5 )) & ( Fx != 0 )
    Needs to read point A and point B.
if ( 0 <=x < X ) & ( 0 <= y < Y ) & ( Fx != 0 ) & ( Fy == 0 )
    Needs to read point A and point B.
if ( 0 <= x < X ) & ( 0 <= y < Y ) & ( Fx == 0 ) & ( Fy ! = 0 )
    Needs to read point A and point C.
if ( 0 <= x < X ) & ( 0 <= y < Y ) & ( Fx != 0 ) & ( Fy != 0 )
    Needs to read point A, pointB, point C and point D.
```

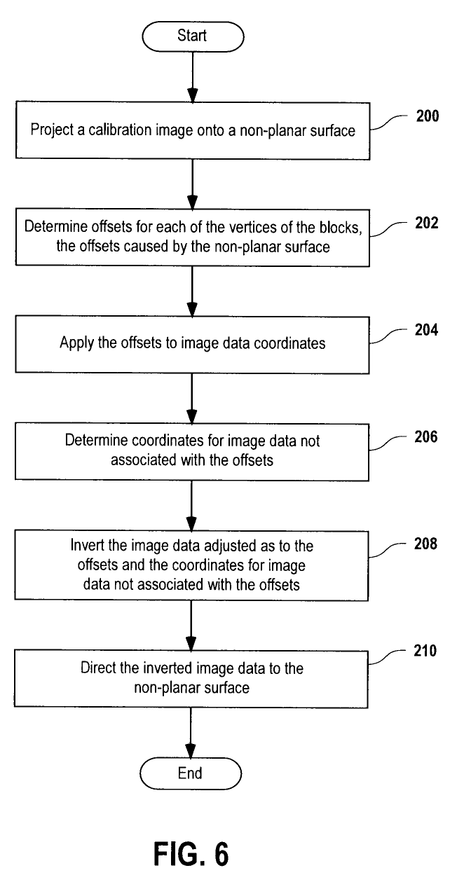

FIG. 6 is a flowchart diagram illustrating the method operations for projecting an image onto a warped surface so that the image is perceived as being projected onto a non-warped surface in accordance with one embodiment of the invention. The method initiates with operation 200 where a calibration image having calibration points defined therein is projected onto the warped surface, i.e., a non-planar surface. The method then advances to operation 202 where offsets for each of the calibration points are determined. These offsets are caused by the distortion introduced by the non-planar surface. It should be noted that the details for the calibration image and the analysis of the effects of the non-planar surface to provide the data for determining the offsets are provided in U.S. application Ser. No. 11/550,180 (Atty docket VP247). The method then proceeds to operation 204 where the offsets are applied to image data coordinates. As discussed above with regard to FIGS. 2-5, a portion of the image data is associated with the offsets and coordinates for the remaining portion are then determined as specified in operation 206. It should be noted that the coordinates for the remaining portion may be determined through interpolation in one embodiment. The method then moves to operation 208 where the image data adjusted as to the offsets and the coordinates for image data not associated with the offsets are both inverted. In one embodiment, the warp core of FIG. 5 includes circuitry configured to achieve this functionality, i.e., apply the offsets to the data and perform bi-linear interpolation through bilinear interpolation circuitry, or some other suitable interpolation to adjust the original image data to negate the effects of the non-planar surface to which the image will be directed to. Further details on operations 202, 204, 206, and 208 may be found in U.S. application Ser. No. 11/550,153 (Atty docket VP248). The method then proceeds to operation 210 where the inverted image is directed to the non-planar surface and the inverted image will negate the distortion effects due to the non-planar surface so that a viewer will observe a non-distorted image. One skilled in the art will appreciate that the calibration image is a separate and distinct image from the image data. In one embodiment, that calibration image may be a plurality of images directed to the warped surface from multiple viewpoints. These viewpoints will result in data sets that are eventually used to define the offsets from the corresponding viewpoints.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A heads up display (HUD) comprising:
a projector configured to project a distorted representation of image data onto a non-planar surface; and
warp image circuitry configured to store offsets to be applied to the image data provided to the projector to generate the distorted representation, the offsets representing respective distances for moving coordinates of a portion of pixels within the image data and stored within a memory region of the warp image circuitry, the portion of pixels corresponding to vertices of polygons, the warp image circuitry further configured to map the vertices of polygons to the non-planar surface.

2. The HUD of claim 1, wherein the warp image circuitry calculates an amount of distortion when mapping the vertices of the polygons to the non-planar surface.

3. The HUD of claim 2, wherein the warp image circuitry is configured to generate an inverse matrix negating the amount of distortion generated from the mapping.

4. The HUD of claim 1, wherein the warp image circuitry includes a counter configured to read the offsets based on a counter value.

5. The HUD of claim 1, further comprising:
a random access memory (RAM) in communication with the warp circuit, the RAM storing the image data.

6. The HUD of claim 1, wherein the warp circuit includes bilinear interpolation circuitry for mapping pixels within vertices of a polygon according to a bilinear interpolation function.

7. A warp image circuit, comprising:
a memory region storing offsets to be applied to image data to generate a distorted representation of the image data;
a core region configured to map the image data to a non-planar surface and calculate an amount of distortion introduced into polygon sections of the image data on the non-planar surface, the core region further configured to determine an inverse of the amount of distortion to be applied to the image data to negate the amount of distortion introduced by the non-planar surface; and
an interface module enabling communication between the memory region and the core region, the interface module including a counter to determine one of whether to read offset data from the memory region to calculate a pixel location or to interpolate the pixel location through the core region.

8. The warp image circuit of claim 7, further comprising:
a register block storing data providing an image size and a size associated with the polygon sections.

9. The warp image circuit of claim 7, further comprising;
an interface to an external random access memory (RAM), the interface configured to evaluate coordinates calculated by the core region to determine whether to access data from the external random access memory associated with the coordinates.

10. The warp image circuit of claim 9, wherein the interface to the external RAM includes circuitry for interpolating a value for the coordinates when it is determined not to access the external random access memory.

11. The warp image circuit of claim 9, further comprising:
an interface block in communication with the core region and the interface to the external RAM, the interface block including a first in first out (FIFO) buffer.

12. The warp image circuit of claim 11, wherein the FIFO buffer functions to synchronize communication between the warp image circuit and external communication blocks.

13. The warp image circuit of claim 12, wherein the external communication blocks includes a host interface, the external RAM, and a projector.

14. A method for projecting an image onto a warped surface so that the image is perceived as being projected onto a non-warped surface, comprising method operations of:
projecting a calibration image onto a non-planar surface;
determining offsets for each of the vertices of the blocks, the offsets caused by the non-planar surface;
applying the offsets to image data coordinates;
determining coordinates for image data not associated with the offsets;
inverting the image data adjusted as to the offsets and the coordinates for image data not associated with the offsets; and
directing the inverted image data to the warped surface.

15. The method of claim 14, wherein the method operations of applying the offsets to image data coordinates, determining coordinates for image data not associated with the offsets, inverting the image data adjusted as to the offsets and the coordinates for image data not associated with the offsets, and projecting the inverted image data onto the warped surface are performed in hardware.

16. The method of claim 14, wherein the directed inverted image data appears non-distorted to a viewer.

17. The method of claim 14 wherein the warped surface is an automobile windshield.

18. The method of claim 14, wherein the subdividing and the determining are performed separately from a remainder of the method operations and the determined offsets are stored for later use with the remainder of the method operations.
